(19) United States
(12) Patent Application Publication
(10) Pub. No.: US 2019/0079846 A1
(43) Pub. Date: Mar. 14, 2019

(54) APPLICATION PERFORMANCE CONTROL SYSTEM FOR REAL TIME MONITORING AND CONTROL OF DISTRIBUTED DATA PROCESSING APPLICATIONS

(71) Applicant: Performance Sherpa, Inc., Saratoga, CA (US)

(72) Inventors: Sadiq SHAIK, Saratoga, CA (US); Ismail DALGIC, Sunnyvale, CA (US)

(21) Appl. No.: 15/699,234

(22) Filed: Sep. 8, 2017

(51) Int. Cl. G06F 11/34; G06F 11/30

(52) U.S. Cl. CPC G06F 11/3409; G06F 11/302

(57) ABSTRACT

The present disclosure provides a computer-implemented method and system for monitoring performance of one or more software applications. The computer-implemented method includes reception of one or more software applications and corresponding sets of data, classification of the one or more sets of software applications and corresponding data, assigning of a unique signature to one or more software applications and corresponding data in each cluster of the one or more clusters of applications in a multi-dimensional hyperspace in real time, mapping the unique signature corresponding to the data in each cluster of the one or more clusters with one or more pre-stored signatures associated with one or more sets of data observed in past, computing one or more configuration values using a multi-dimensional optimization algorithm, and submitting the one or more sets of data with the one or more configuration values to a distributed data processing system.

### TECHNICAL FIELD

The present disclosure relates to the field of application performance management and, in particular, relates to an application performance control system for real time efficient management of distributed data processing applications.

### BACKGROUND

Today businesses rely on software applications built upon modern distributed software platforms for their day to day operations. Such systems are capable of processing tens of Terabytes of data every hour. This was impossible to do economically a few years ago when data was processed in traditional database platforms built using RDBMS technology. The list of such databases included Oracle, PostgreSQL and MySQL. These systems are optimized to handle smaller data volumes. Modern databases built using distributed systems principles come in several architectures. Two popular styles of architecture are Big Data platforms and NoSQL architecture. These modern databases can handle much larger volumes of data economically. Example of popular big data platforms are Hadoop and Spark. Two of many popular NoSQL platforms are Cassandra and MongoDB.

While modern platforms change the unit economics of data processing, they run software sluggishly and use hardware inefficiently for data processing. This forces IT administrators to spend 4-10× more on hardware and expensive performance optimization consultants. The inefficiency is rooted in the design of the platforms—they handle data storage and processing using multiple computers in parallel and use multiple layers of software abstraction to mask the complexity. Traditional approaches of designing code compilers and optimizers using statistics are useful to when processing a narrow range of compute workloads that run on a small number of computers. The techniques don't scale as well on distributed databases. This is because distributed systems have multiple layers of software abstraction, where each layer does local compilation and optimization. The local optimization disregards resource needs and code bottlenecks in layers below and above. The loosely-coupled nature of the layered design, where layers are owned by different organizations, makes it hard if not impossible to design a global compiler/optimizer for the full stack.

For this reason, the world of databases needs new techniques for code optimization on distributed systems. Today, this doesn't exist. Human IT operators continuously monitor the huge amount of data and optimize the performance of these data processing systems. As distributed systems become more pervasive, there is an urgent need to scale such systems by making data processing more efficient.

Multivariable feedback control Analysis and Design by Sigurd Skogestad and Ian Postlethwaite (Nov. 4, 2005), discloses concept of multi-dimensional feedback control system. CS-229 course materials, Lecture notes 7a, Unsupervised Learning, K-means clustering by Stanford University, discloses concept of cluster analysis for creating one or more clusters of applications in a multi-dimensional hyperspace. Genetic Algorithms in search, optimization, and machine learning by David E Goldberg (1989), discloses concept of genetic algorithm for optimization of cost metric. Bayesian approach to global optimization: theory and applications, Kulwer Academic by Jonas Mockus (2013) discloses concept of Bayesian optimization algorithm to provide an effective framework for the practical solution of discrete and nonconvex optimization problems. Particle Swarm Optimization by Kennedy J., Eberhart R. (1995), discloses concept of Particle Swarm Optimization algorithm for optimization of the cost metric. In addition, an Idea Based on Honey Bee Swarm for Numerical Optimization by Karaoga, Dervis (2005), also discloses concept of artificial bee colony algorithm for optimization of the cost metric.

### SUMMARY

In a first example, a computer-implemented method is provided. The computer-implemented method may monitor performance of one or more software applications hosted on an application hosting platform. The computer-implemented method may include a first step of reception of one or more sets of data associated with each of the corresponding one or more software applications in real time. In addition, the computer-implemented method may include a second step of classification of the one or more sets of data associated with each of the corresponding one or more software applications in real time. Moreover, the computer-implemented method may include a third step of assigning a unique signature to one or more software applications and its associated data set in each cluster of one or more clusters of applications in a multi-dimensional hyperspace, in real time. Further, the computer-implemented method may include a fourth step of mapping of the unique signature corresponding to the one or more software applications and data sets in each cluster of the one or more clusters with one or more pre-stored signatures associated with the one or more sets of software application and data set observed in past. Furthermore, the computer-implemented method may include a fifth step of computation of one or more configuration values for one or more software applications and data sets in each cluster of the one or more clusters of applications in a multi-dimensional hyperspace, in real time. Also, the computer-implemented method may include a sixth step of submission of the one or more software applications and corresponding sets of data with the one or more configuration values to a distributed data processing system. The classification may be done by creating the one or more clusters. Each of the one or more clusters may include the one or more data of the one or more sets of data similar to each other. The one or more software applications and sets of data may be clustered based on determination of whether the currently received one or more software applications and sets of data are similar to a pre-stored software application and its set of data. The mapping may be done for determining whether the unique signature corresponding to the one or more software applications and data in each cluster has been observed in past or not. The one or more configuration values may be computed for minimizing a cost metric associated with execution of the one or more applications and sets of data in real time. The cost metric may be minimized for input as an error function for a feedback control matrix. In addition, the one or more configuration values may be computed based on a pre-determined criterion. The pre-determined criterion may be based on a multi-dimensional optimization algorithm, including, but not limited to, Genetic Algorithm, Artificial Bee Colony, Bayesian Optimization Algorithm, Particle Swarm Optimization Algorithm, and Simulated Annealing Algorithm.

In an embodiment of present disclosure, the computer-implemented method may include analysis of execution of the one or more software applications and their sets of data submitted to the distributed data processing system in real time. The analysis may be done for obtaining a completion status, one or more performance metrics and one or more data execution logs corresponding to the one or more software applications.

In an embodiment of present disclosure, the computer-implemented method may include analysis of the completion status and the one or more performance metrics for determining one or more issues associated with performance of the one or more software applications in real time.

In an embodiment of the present disclosure, the computer-implemented method further includes calculation of a cost metric associated with execution of the one or more software applications in real time. The cost metric is calculated based on the one or more performance metrics associated with the one or more software applications and their sets of data. The calculated cost metric is used as an input for optimization for similar software applications and sets of data in future.

In an embodiment of present disclosure, the computer-implemented method may include storage of the completion status, the one or more performance metrics, one or more states of learning and one or more details associated with an infrastructure. In addition, the computer-implemented method may include storage of one or more details associated with a platform, one or more details associated with the one or more software applications, one or more application signatures, one or more run time metrics and the one or more data execution logs.

In an embodiment of present disclosure, the pre-determined criterion may include assigning one or more specific configuration values to a first set of data of the one or more data in each cluster. The one or more specific configuration values are assigned when the unique signature corresponding to the first set of data of the one or more data is observed in the past. The one or more specific configuration values are assigned by utilizing a learning engine.

In another embodiment of present disclosure, the pre-determined criterion may include initialization of a new learning object and a learning algorithm for producing a first set of configuration values when the unique signature corresponding to a second software application and set of data of the one or more software applications and their data are not observed in past.

In an embodiment of present disclosure, the computer-implemented method may include transmission of the one or more configuration values to the distributed data processing system in real time when the unique signature has been observed in past and when the unique signature is not observed in past.

In an embodiment of present disclosure, the cost metric may be optimized by utilizing one or more optimization algorithms. The one or more optimization algorithms may include Genetic Algorithm, Artificial Bee Colony, Bayesian Optimization Algorithm, Particle Swarm Optimization Algorithm and Simulated Annealing Algorithm.

In an embodiment of present disclosure, the computer-implemented method may include termination of execution of one or more processes that are likely to fail. In addition, the termination may be done to prevent consumption of more than allocated capacity of resources.

In an embodiment of present disclosure, the submission may be done by submission of a first set of information to the distributed data processing system in real time for optimization of configuration. The first set of information may include workload information, system information and past set of data. The workload information may include an execution engine, an application code and the one or more sets of data to be processed. The system information may include a number of nodes, resources available and resources in use. The past set of data may include values of past inputs, a controllable variable and outputs.

In an embodiment of present disclosure, the controllable variables may include a choice of software stack layers and libraries, configuration parameters for the chosen software stack layers and libraries, number of database connection threads and number of hardware nodes. In addition, the controllable variables may include type of hardware nodes, compiler hints, degree of parallelism of each application, introduction of new domain specific artifacts and efficient ways to read/write files from and to disk. Moreover, the controllable variables may include additional caching layers and use of more efficient, alternative implementations of UDFs and operators.

In a second example, a computer system is provided. The computer system may include one or more processors and a memory coupled to the one or more processors. The memory may store instructions which, when executed by the one or more processors, may cause the one or more processors to perform a method. The method monitors performance of one or more software applications hosted on an application hosting platform. The method may include a first step of reception of one or more sets of data associated with each of the corresponding one or more software applications in real time. In addition, the method may include a second step of classification of the one or more sets of data associated with each of the corresponding one or more software applications in real time. Moreover, the method may include a third step of assigning a unique signature to one or more software applications and their data sets in each cluster of one or more clusters of applications in a multi-dimensional hyperspace, in real time. Further, the method may include a fourth step of mapping of the unique signature corresponding to the one or more software applications and data sets in each cluster of the one or more clusters with one or more pre-stored signatures associated with the one or more sets of software applications and their data sets observed in past. Furthermore, the method may include a fifth step of computation of one or more configuration values for mapped one or more software applications and their data in each cluster of the one or more clusters of applications in a multi-dimensional hyperspace, in real time. Also, the method may include a sixth step of submission of the one or more software applications and sets of data with the one or more configuration values to a distributed data processing system. The classification may be done by creating the one or more clusters. Each of the one or more clusters may include the one or more software applications and their data sets of the one or more software applications and sets of data similar to each other. The one or more software applications and their sets of data may be clustered based on determination of whether the currently received one or more software applications and their sets of data are similar to a pre-stored software application and its set of data. The mapping may be done for determining whether the unique signature corresponding to the one or more software applications and data in each cluster has been observed in past or not. The one or more configuration values may be computed for minimizing a cost metric associated with execution of the one or more software applications in real time. The cost metric may be minimized for input as an error function for a feedback control matrix. In addition, the one or more configuration values may be computed based on pre-determined criterion. The pre-determined criterion may be based on a multi-dimensional optimization algorithm.

In a third example, a computer-readable storage medium is provided. The computer-readable storage medium encodes computer executable instructions that, when executed by at least one processor, performs a method. The method monitors performance of one or more software applications hosted on a distributed data processing platform. The method may include a first step of reception of one or more sets of data associated with each of the corresponding one or more software applications in real time. In addition, the method may include a second step of classification of the one or more sets of data associated with each of the corresponding one or more software applications in real time. Moreover, the method may include a third step of assigning a unique signature to the software application and one or more data in each cluster of one or more clusters of applications in a multi-dimensional hyperspace, in real time. Further, the method may include a fourth step of mapping of the unique signature corresponding to the one or more software applications and data in each cluster of the one or more clusters with one or more pre-stored signatures associated with the one or more software applications and their sets of data observed in past. Furthermore, the method may include a fifth step of computation of one or more configuration values for one or more software applications and data in each cluster of the one or more clusters of applications in a multi-dimensional hyperspace, in real time. Also, the method may include a sixth step of submission of the one or more software applications and their sets of data with the one or more configuration values to a distributed data processing system. The classification may be done by creating the one or more clusters. Each of the one or more clusters may include the one or more software applications and their data sets of the one or more software applications and their sets of data similar to each other. The one or more software applications and their sets of data may be clustered based on determination of whether the currently received one or more software applications and their sets of data are similar to a pre-stored software application and its set of data. The mapping may be done for determining whether the unique signature corresponding to the one or more software applications and data in each cluster has been observed in past or not. The one or more configuration values may be computed for minimizing a cost metric associated with execution of the one or more software applications in real time. The cost metric may be minimized for input as an error function for a feedback control matrix. In addition, the one or more configuration values may be computed based on pre-determined criterion. The pre-determined criterion may be based on a multi-dimensional optimization algorithm.

### BRIEF DESCRIPTION OF FIGURES

Having thus described the invention in general terms, reference will now be made to the accompanying drawings, which are not necessarily drawn to scale, and wherein:

FIG. 1 illustrates an interactive computing environment for monitoring performance of one or more software applications hosted on an application hosting platform;

FIG. 2 illustrates a block diagram of an application performance control system, in accordance with various embodiments of the present disclosure;

FIG. 3 illustrates a graph showing an example of performance improvement of the one or more software applications, in accordance with various embodiments of the present disclosure;

FIG. 4 illustrates a graph showing cluster analysis in a 2-dimensional space;

FIG. 5 illustrates a block diagram of the multi-dimensional feedback control system;

FIG. 6 illustrates a flow chart for monitoring the performance of the one or more software applications hosted on the application hosting platform, in accordance with various embodiments of the present disclosure, and

FIG. 7 illustrates a block diagram of a computing device, in accordance with various embodiments of the present disclosure.

It should be noted that the accompanying figures are intended to present illustrations of exemplary embodiments of the present invention. These figures are not intended to limit the scope of the present invention. It should also be noted that accompanying figures are not necessarily drawn to scale.

### DETAILED DESCRIPTION

Reference will now be made in detail to selected embodiments of the present invention in conjunction with accompanying figures. The embodiments described herein are not intended to limit the scope of the invention, and the present invention should not be construed as limited to the embodiments described. This invention may be embodied in different forms without departing from the scope and spirit of the invention. It should be understood that the accompanying figures are intended and provided to illustrate embodiments of the invention described below and are not necessarily drawn to scale. In the drawings, like numbers refer to like elements throughout, and thicknesses and dimensions of some components may be exaggerated for providing better clarity and ease of understanding.

It should be noted that the terms “first”, “second”, and the like, herein do not denote any order, ranking, quantity, or importance, but rather are used to distinguish one element from another. Further, the terms “a” and “an” herein do not denote a limitation of quantity, but rather denote the presence of at least one of the referenced item.

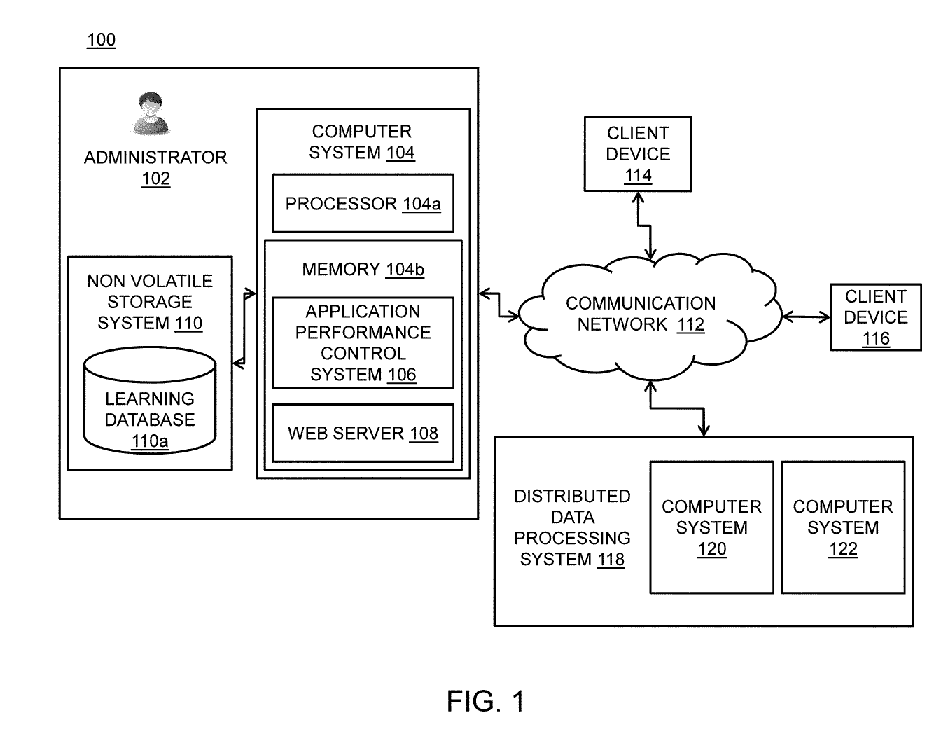

FIG. 1 illustrates an interactive computing environment 100 for monitoring performance of one or more software applications in real time, in accordance with various embodiments of the present disclosure. The interactive computing environment 100 shows a plurality of system elements for monitoring and managing performance of one or more distributed data processing applications in real time. The plurality of system elements collectively enables real time performance management of the one or more software applications for providing a high quality of user experience. The interactive computing environment 100 detects, diagnoses, and remedies one or more issues related to performance of the distributed data processing applications to maintain an expected level of quality of service for end users.

The interactive computing environment 100 includes computer system 104, an application performance control system 106, a web server 108, a non-volatile storage system 110 and a distributed data processing system 118. An administrator 102 is associated with the computer system 104 for monitoring one or more operations performed by the application performance control system 106. Further the distributed data processing system 118 includes one or more computer systems 120-122. Examples of the distributed data processing system 118 include Hadoop, Spark and the like. In addition, the interactive computing environment 100 includes a communication network 112, a client device 114 and a client device 116. The above stated system components of the interactive computing environment 100 enable real time monitoring and real time performance management of the one or more software applications running on the distributed data processing system 118. The system components measure and analyze performance metrics of the distributed data processing applications in real time to detect and correct the one or more issues which are slowing down or affecting the performance of the one or more software applications.

The computer system 104 includes a processor 104a and a memory 104b. In an embodiment of the present disclosure, the processor 104a may be a single processor. In another embodiment of the present disclosure, the processor 104a may be multiple processors. The memory 104b corresponds to a random access memory or any other dynamic storage device. The memory 104b stores one or more instructions which are executed by the processor 104a. The computer system 104 hosts the application performance control system 106. The computer system 104 may be a cluster of computers or computing devices viewing and monitoring the performance of the one or more software applications. The computer system 104 may be coupled to various other computer systems. In addition, the computer system 104 may include one or more storage devices. The computer systems coupled to the computer system 104 may access data stored in the one or more storage devices at any time. In an embodiment of the present disclosure, the computer system 104 may be coupled to a computer system network in a local area network (LAN) configuration. In another embodiment of the present disclosure, the computer system 104 may be coupled to a computer system network in a wide area network (WAN) configuration.

The computer system 104 may include one or more central processing units or one or more processors. In addition, the computer system 104 is associated with the non-volatile storage system 110. Examples of the non-volatile storage system 110 include but may not be limited to hard drive, flash memory, and a solid state drive (SSD). The non-volatile storage system 110 includes a learning database 110a. Moreover, the non-volatile storage system 110 is connected to a random access memory through a bus.

The distributed data processing system 118 enables the users and programmers to create, maintain, and process data for the one or more software applications. The users and programmers can store, retrieve, update, and process data in the distributed data processing system 118. The users and programmers can extract information from the distributed data processing system 118 in response to a query. The computer systems 120-122 may include one or more hardware components. The one or more hardware components include one or more central processing units, one or more buses, memory power supply and non-volatile memory.

The application performance control system 106 monitors performance and detects issues with the one or more software applications in real time. In addition, the application performance control system 106 ensures a quality experience for one or more users associated with the client device 114 and the client device 116. The client device 114 and the client device 116 may be any type of device for hosting and using a web browser by the one or more users, which is used to administer the distributed data processing system 118 and the computer system 104. Examples of the client device 114 and the client device 116 may include smart phones, laptops, desktop computers, personal digital assistants and the like. Moreover, the client devices 114-116 are connected to the internet through the communication network 112. Further, the client devices 114-116 may be connected to the internet through a data connection provided by a telecom service provider. The telecom service provider is associated with a subscriber identification module card located inside the client devices 114-116. Furthermore, the client devices 114-116 may be connected to the internet through a WiFi connection.

The application performance control system 106 models the user-defined performance of the one or more software applications based on one of several cost model functions that is best fit for the application. The cost functions are proxies for one or a combination of throughput, server footprint and latency that users experience with the application. The application performance control system 106 may monitor and control the one or more software applications for real time application performance control. In an embodiment of the present disclosure, the application performance control system 106 may perform monitoring and management of a single application at a time. In another embodiment of the present disclosure, the application performance control system 106 may perform monitoring and management of multiple applications at the same time. The one or more software applications may be any type of applications that run on top of the distributed data processing system 118. Examples of the applications include Business Intelligence (BI) applications, Marketing Analytics, Fraud Detection, and the like. The application performance control system 106 acts to detect and correct issues related to the performance of the one or more software applications and other system components in a complex computing environment.

The application performance control system 106 may include one or more components for monitoring and controlling the performance of the one or more software applications. The one or more components tune performance of the distributed data processing system 118. The performance is tuned in such a way that the application performance control system 106 optimizes each specific application and data related to the application. The application performance control system 106 can adapt to new software applications and varying data sizes. The one or more components of the application performance control system 106 may reside on same computer system, different computer systems or an arbitrary combination of computer systems.

The application performance control system 106 identifies one or more problems or issues indicative to a performance problem. In addition, the application performance control system 106 may identify sources of problems, identify root causes of problems, recommend one or more measures to improve performance, and optionally apply such measures automatically. The application performance control system 106 collects and analyzes performance data from a plurality of distributed data processing systems and calculates various performance metrics.

The application performance control system 106 optimizes performance of each of the one or more software applications monitored in real time. The computer system 104 hosting the application performance control system 106 can be either a cloud based service, or can be deployed on-premises along with the plurality of distributed data processing systems it manages. In an embodiment of the present disclosure, the application performance control system 106 may utilize an agent to gather a plurality of performance metrics or rely on a monitoring service that is built into the system. In an embodiment of the present disclosure, the application performance control system 106 tracks the plurality of performance metrics. The plurality of performance metrics include but may not be limited to CPU usage, input/output activity, database accesses, memory usage, network bandwidth and network latency.

The application performance control system 106 performs root cause analysis for determination of one or more root causes of one or more issues related to the performance of the applications. The application performance control system 106 continuously synthesizes new solutions to tune software layers in the context of a customer, application, platform, and infrastructure. The application performance control system 106 synthesizes new solutions to minimize hardware footprint and auto-provisions additional hardware only when necessary to meet service level agreements. In addition, the application performance control system 106 monitors a speed at which transactions are performed by end users.

It may be noted that in FIG. 1, the application performance control system 106 monitors the performance of the one or more software application running on the client devices 114-116 associated with corresponding users; however, those skilled in the art would appreciate that there are more number of client devices associated with more number of users.

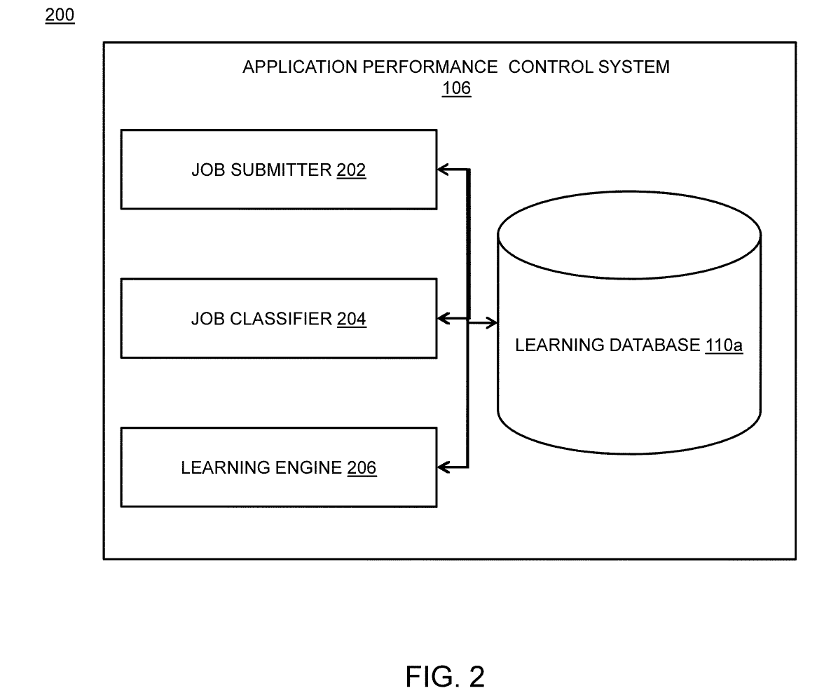

FIG. 2 illustrates a block diagram 200 of the application performance control system 106, in accordance with various embodiments of the present disclosure. It may be noted that to explain the system elements of FIG. 2, references will be made to the system elements of FIG. 1. The block diagram 200 depicts the system architecture of the application performance control system 106. The system architecture of the application performance control system 106 includes a plurality of components. The plurality of components collectively performs the monitoring and control of the performance of the one or more software applications.

The plurality of components of the application performance control system 106 includes a job submitter 202, a job classifier 204, a learning engine 206 and the learning database 110a. In an embodiment of the present disclosure, the plurality of components may include a client agent (not shown in the figure). The application performance control system 106 is a combination of one or more plugins, one or more servers, one or more databases and the like for the real time performance management of the one or more software applications. The application performance control system 106 is a tool that can automatically synthesize performance optimization knowledge, build composite stacks, tune the stacks and run the one or more applications on the one or more stacks it builds and tunes. The administrator 102 submits one or more jobs to the software associated with the application performance control system 106. Further one or more jobs may correspond to one or more sets of data. The one or more sets of data include a database table, a statistical data matrix and the like. In addition, the one or more sets of data correspond to data associated with the one or more software applications whose performance is to be monitored. The one or more software applications include Hadoop Map Reduce programs, Apache Hive queries, Apache Spark programs, and the like.

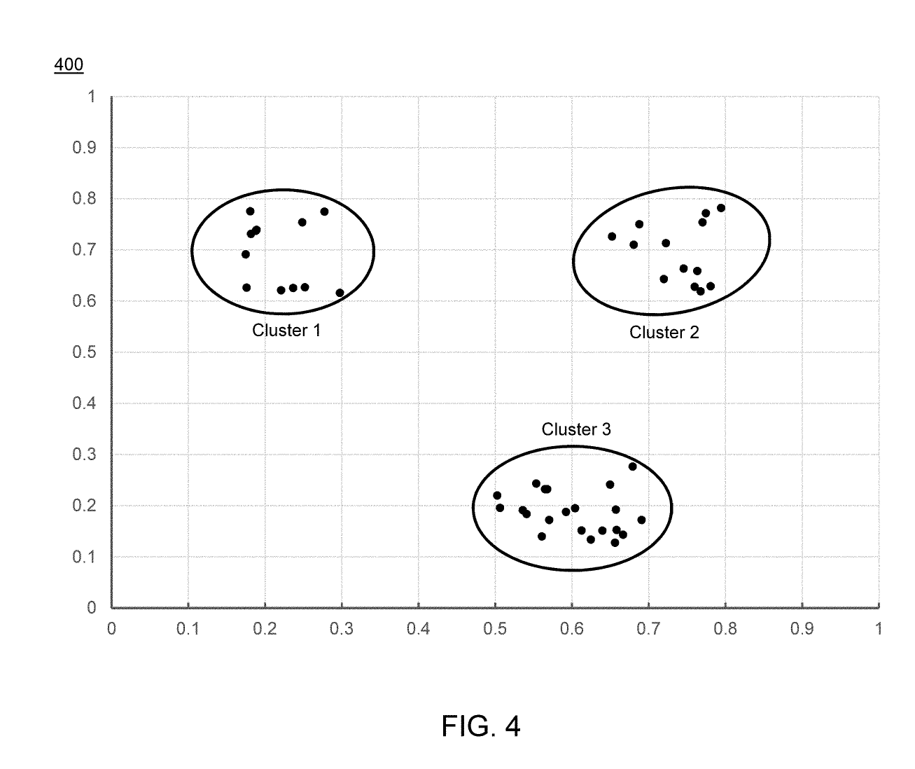

The one or more plugins include the job submitter 202, the job classifier 204 and a software component called circuit breaker. The one or more plugins are the software component that acts as an add-on for the distributed data processing system 118 associated with the application performance control system 106. The administrator 102 submits the one or more sets of data associated with each of the corresponding one or more software application on the application performance control system 106 through the job submitter 202. The software application with the one or more sets of data may be executed in a distributed environment or in parallel. The application may be executed in a queue. The job submitter 202 transmits metadata information about the software application and the one or more sets of data to the job classifier 204. The job classifier 204 classifies the one or more sets of data associated with each of the corresponding one or more software applications. Further classification is done by creating one or more clusters of applications in a multi-dimensional hyperspace, using cluster analysis. In an example, the cluster analysis is described in Stanford University CS-229 course materials, Lecture Notes 7a, Unsupervised Learning, k-means clustering. FIG. 4 illustrates an example of cluster analysis in a 2-dimensional space, with 3 clusters of data points shown in the example. In the present invention, the multiple hyperspace dimensions for the cluster analysis may include, but not limited to, the input data size, a hash of the application program, time-series values of performance metrics such as memory consumption, CPU usage, network usage, disk I/O rate, etc. Moreover, each cluster of the one or more clusters includes one or more of the software applications and one or more sets of data. In addition the job classifier 204 determines whether the software application and one or more sets of data submitted are similar to pre-stored sets of software application and data that have been submitted in the past. Moreover the job classifier 204 assigns a unique signature for each cluster of the one or more clusters. Further each of the one or more sets of data belonging to particular cluster are tagged with the unique signature.

The application performance control system 106 utilizes the software component called circuit breaker. The circuit breaker prevents an application from executing an operation that is likely to fail. In addition, the circuit breaker can be utilized or incorporated to steer away from breaches in service level agreements (SLAs). Moreover, the circuit breaker can be utilized for preventing the application from consuming more than allocated capacity. Furthermore, the circuit breaker utilizes predictive models for early detection and prevention of service level agreement breaches.

Further, the job submitter 202 sends a request to the learning engine 206. The job submitter 202 sends a request for one or more configuration values for each of the one or more applications and their sets of data from the learning engine 206. The learning database 110a stores one or more states of learning, details of infrastructure, details of platform, details of applications, application signatures, run-time metrics, logs, and the like. Furthermore, the learning engine 206 accesses the learning database 110a. In an embodiment of the present disclosure, the learning engine 206 may send a request to the learning database 110a for real time access. The learning database 110a responds to the request by the learning engine 206.

The learning database 110a stores a record of the signature corresponding to the one or more data in each cluster submitted on the software platform in past. The learning engine 206 maps the signature corresponding to each of the one or more software applications and data in a cluster to one or more pre-stored signatures in the learning database 110a. The mapping is done for determining whether the signature corresponding to each of the one or more jobs has been observed in the past or not. The learning engine 206 computes one or more configuration values for the one or more software applications and data in each cluster of the one or more clusters of applications in a multi-dimensional hyperspace, in real time. The one or more configuration values are computed for minimizing a cost metric associated with execution of the one or more sets of data in real time. The cost metric is minimized for input as an error function for a feedback control matrix. The one or more configurations values are computed based on a pre-determined criterion. The pre-determined criterion is based on a multi-dimensional optimization algorithm.

In an embodiment of present disclosure, the pre-determined criterion includes assigning one or more specific configuration values to a first set of data of the one or more data in each cluster. The one or more specific configuration values are assigned when the unique signature corresponding to the first set of data of the one or more software applications is observed in the past. In another embodiment of present disclosure, the pre-determined criterion includes initialization of a new learning object and a learning algorithm for producing a first set of configuration values when the unique signature corresponding to a second software application and its set of data of the one or more software applications and data are not observed in past. In an embodiment of the present disclosure, the learning engine 206 transmits the one or more configuration values to the job submitter 202 when the signature has been observed in the past and when the signature has not been observed in the past.

The job submitter 202 submits the software application and one or more sets of data with the one or more configuration values to the distributed data processing system 118. The job submitter 202 submits a workload (one or more jobs) to the distributed data processing system 118 to determine an optimal configuration of run-time environment in each layer of the software stack associated with each of the one or more software applications. The optimal configuration is determined to enable execution of the workload for minimizing the cost metric associated with the execution of the one or more sets of data. In general, the cost metric is a function of one or more performance metrics, including but not limited to resource consumption, system throughput and execution time. In addition, the resource consumption metrics include memory, CPU usage, network, disk input/output and the like.

The job submitter 202 provides a first set of information to the distributed data processing system 118 during submission of the workload for the optimization of configuration. The first set of information includes workload information, system information and past sets of software applications and data. The workload information includes an execution engine, application code, data to be processed, and the like. The system information includes a number of nodes, resources available, resources in use and the like. The past set of data includes values of past inputs, controllable variables, and outputs.

Further, the application performance control system 106 sets one or more controllable variables based on the first set of information. Values of the one or more controllable variables are used to optimize the cost metric. The one or more controllable variables includes a choice of software stack layers and libraries, configuration parameters for the chosen software stack layers and libraries, number of database connection threads, number of hardware nodes and type of hardware nodes. In addition, the one or more controllable variables includes compiler hints, degree of parallelism of each application, introduction of new domain specific artifacts and efficient ways to read/write files from / to disk. Moreover, the one or more controllable variables include additional caching layers and use of more efficient, alternative implementations of UDFs (User Defined Functions) and operators.

The configuration values are provided by the learning engine 206. In addition, the job submitter 202 starts monitoring the execution of each of the one or more sets of data. Accordingly, the job submitter 202 sends a query to the distributed data processing system 118 for obtaining a completion status of the execution of each of the one or more sets of data. The completion status indicates whether the execution of the each of the one or more data has succeeded or failed. Also, the job submitter 202 may send a query to the distributed data processing system 118 for obtaining the one or more performance metrics.

The job submitter 202 obtains the completion status and the one or more performance metrics from the distributed data processing system 118. Accordingly, the job submitter 202 sends the completion status and the one or more performance metrics to the learning engine 206. The learning engine 206 analyzes the completion status and the one or more performance metrics to determine the one or more issues associated with the performance of the one or more software applications in real time. The learning engine 206 computes and stores the cost metric based on the one or more performance metrics. The cost metric is used as input for optimization of subsequent invocations of similar workloads.

The learning engine 206 models the combination of run-time platform (distributed data processing system 118) and infrastructure (hardware+OS) as a non-linear time invariant system for the duration of each application execution.

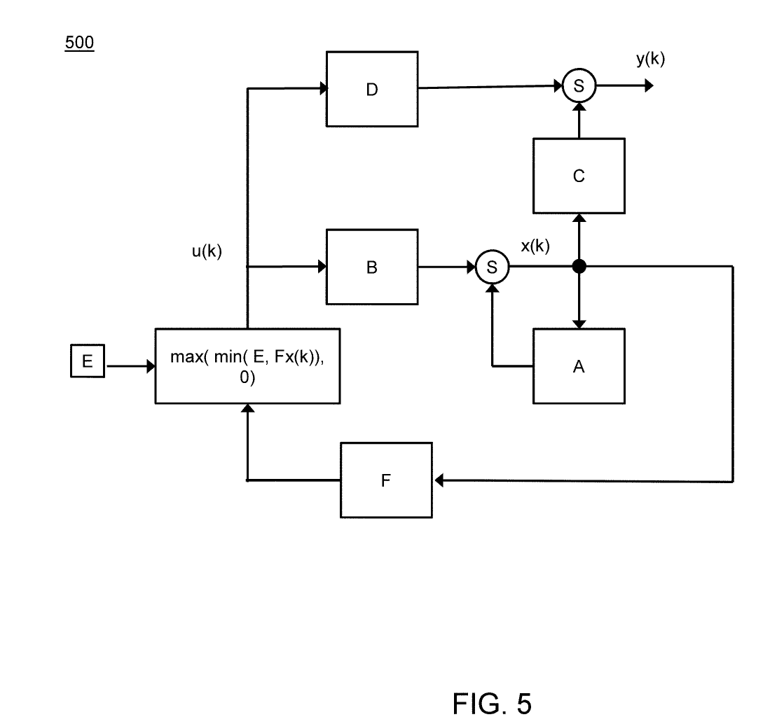

The learning engine 206 implements a multi-dimensional feedback control system for adaptive performance control. In an example, the multi-dimensional feedback control system is described by Sigurd Skogestad Ian Postlethwaite in Multivariable Feedback Control: Analysis and Design (Nov. 4, 2005). The block diagram of the multi-dimensional feedback control system is shown in FIG. 5. The learning engine 206 utilizes the cost metric as an input for an error function for a feedback control matrix. The learning engine 206 utilizes the cost values as an error function which is fed to an actuating signal that feeds a control module (explained below in detail). The control system can be used to achieve continuous performance optimization. The control system works as per the difference equations shown below:

x(k+1)=Ax(k)+Bu(k)

y(k)=Cx(k)+Du(k)

u(k)=max(min(E,Fx(k)),0)

Here, x(k) corresponds to a vector which denotes the internal states of the system. The internal states include one or more state variables that may not all be observable at any or all points of time. The one or more state variables include allocation and usage of memory buffers, CPU utilization, disk spills, I/O, garbage collection, parallelization and the like. In addition, the time series state vector x(t) can be constructed when processing times of subroutines in an application and system resources consumed by the application/compute workload can be measured to a reasonable degree of precision.

Here, A, B, C, D, and E are matrices which represent a physical system, and k denotes time (modeled as a discrete variable). The physical system corresponds to a run time platform. The physical system includes an operating system, a container, a middleware, a database, a distributed system on which applications run and the like. The physical system is the discrete time physical system that uses sensors that sample system states and control system that produces control inputs to the system at discrete intervals. As a new user application is submitted onto the platform, it is logically modeled as a different physical system. In other words, A, B, C, D matrices are different for each distinct user application that gets submitted on the platform.

Here, u(k) corresponds to a function which denotes one or more control inputs which control the performance of the application (y(k)). The control inputs to the system include. the vector E that models maximum of system resources allocated to the program. In addition, the system resources may include memory, CPU, disk i/o, network capacity, and time allocated aggregated across all the distributed processes. Further the control inputs to the system include cross product of the feedback gain matrix F and observable internal system states x(k).

Here, y(k) corresponds to an output signal. The output signal provides information related to application latency, throughput, CPU utilization, memory utilization and the like. Furthermore, the control system utilizes a tracking signal through which the users can specify the service level agreement (SLA) for an individual application or a Directed Acyclic Graph (DAG) of applications. In addition, the control system utilizes an error signal which is a function of system states that expresses arbitrarily complex service level agreements (SLAs) that span an application instance or a chain of applications. Moreover, the control system utilizes feedback gains modeled in a parametric form, matrix F, for a given type of service level agreement (SLA). The control system optimizes the one or more controllable variables (measured output) for optimizing the cost metric.

In an embodiment of the present disclosure, the control system is a local control system which runs as a separate entity for each of the distributed data processing system 118 being controlled. In another embodiment of the present disclosure, the control system is a global control system running in cloud which allows the control system to tune faster and learn faster by learning about application characteristics from the plurality of distributed data processing systems that it controls.

The learning engine 206 uses a model of each distinct workload as an isolated physical system. It uses an optimization algorithm to empirically accomplish pole-placement for the closed loop system. More specifically, the algorithm computes the feedback control matrix Fin such a way as to place Eigen values of closed loop physical system in left half of the complex plane. This ensures that the system tracks the desired control input without instability. In an embodiment of the present disclosure, the learning engine 206 may utilize a Genetic Algorithm (GA) for optimization of the cost metric. In an example, the Genetic Algorithm (GA) is described by David E Goldberg in Genetic Algorithm in Search, Optimization and machine Learning (1989). In another embodiment of the present disclosure, the learning engine 206 may utilize an Artificial Bee Colony (ABC) algorithm for optimization of the cost metric. In an example, the Artificial Bee Colony (ABC) algorithm is described by Karaboga, Dervis (2005) in An Idea Based on Honey Bee Swarm for Numerical Optimization. In another embodiment of the present disclosure, the learning engine 206 may utilize a Bayesian Optimization algorithm for optimization of the cost metric. In an example, the Bayesian Optimization Algorithm is described by Jonas Mockus in Bayesian approach to global optimization: theory and applications. In yet another embodiment of the present disclosure, the learning engine 206 may utilize a Particle Swarm Optimization algorithm for optimization of the cost metric. In an example, The Particle Swarm Optimization Algorithm is described by Kennedy J., Eberhart R. in Particle Swarm Optimization, proceedings of IEEE international conference on Neural Networks. IV. pp 1942-1948. In yet another embodiment of the present disclosure, the learning engine 206 may utilize a Simulated Annealing algorithm for optimization of the cost metric. In yet another embodiment of the present disclosure, the learning engine 206 may utilize any other algorithm suitable for optimization of the cost metric in a multi-dimensional search space.

The job classifier 204 performs cluster analysis on each of the one or more data of the one or more sets of data submitted by the job submitter 202. Cluster analysis classifies the workloads into groups of workloads with similar performance characteristics (A, B, C, D matrices). As a result of the cluster analysis, the one or more data are categorized into one or more clusters, where each cluster of the one or more clusters contains one or more data which are similar to each other. The job classifier 204 performs the cluster analysis for calculation of the signature for each of the one or more sets of data submitted by the job submitter 202. In an embodiment of the present disclosure, each data of the one or more sets of data belonging to same cluster is assigned the unique signature.

The matrices A, B, C, and D may change over time as a result of application changes introduced by software patches, changes in data volumes and skews as input data changes organically over time, changes in platform due to platform upgrades/patches, and hardware upgrades. The learning engine 206 adapts the feedback control matrix F according to such changes.

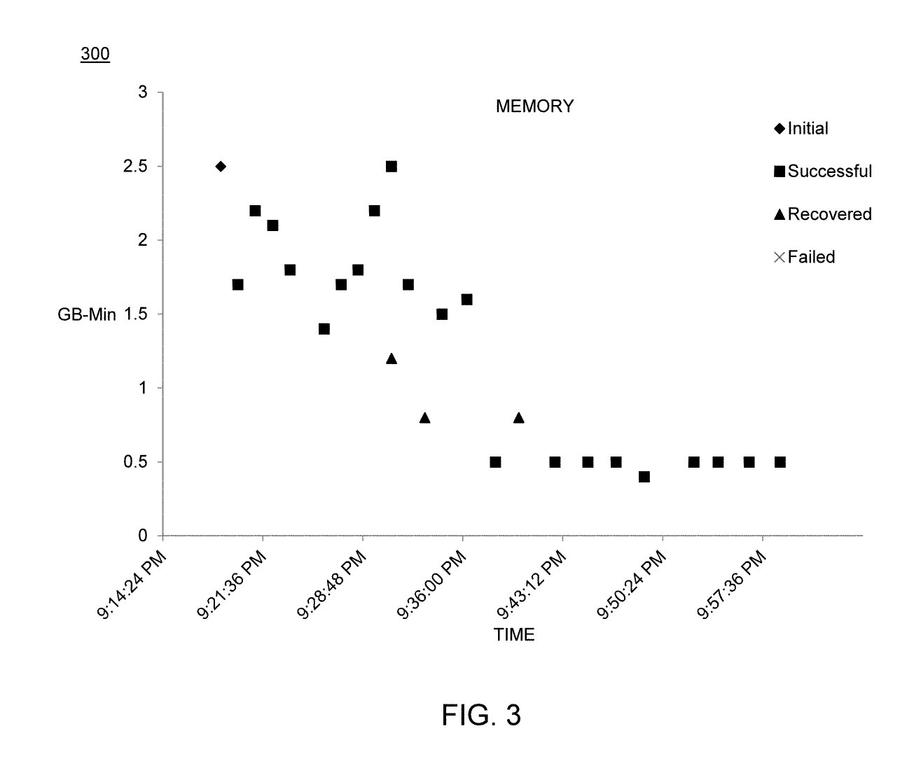

FIG. 3 illustrates a graph 300 showing an example of performance improvement, in accordance with an embodiment of the present disclosure. A Hadoop MapReduce data processing system is controlled by the application performance control system 106 described herein. The workload controlled in this example is TeraSort, a well known Hadoop MapReduce benchmark. The cost metric is chosen to be Memory, in this example. The same TeraSort workload was submitted successively to the system 24 times in a row, corresponding to 24 distinct jobs. A chart shows the resulting memory consumption (in units of gigabytes multiplied by minutes) for each job submission (time of submission).The chart includes an X-axis and a Y-axis. The X-axis represents the consumption of memory in unit Gigabytes multiplied by minutes (GB-Min). The Y-axis represents the time of submission of the jobs in unit time. The initial job, whose result is represented with a diamond shaped dot in the chart, was submitted such that the application performance control system 106 is disabled, so as to provide a baseline for comparison. For all subsequent jobs, the application performance control system 106 was enabled. The Subsequent jobs may include one or more successful job, one or more recovered jobs and one or more failed jobs. The one or more successful jobs are represented by one or more square shaped dots. Further the one or more recovered jobs are represented by one or more triangular shaped dots. Furthermore the one or more failed dots are represented by one or more cross shaped dots. It is evident from the chart that the present disclosure described herein lowers memory consumption by a factor of 5 in this example.

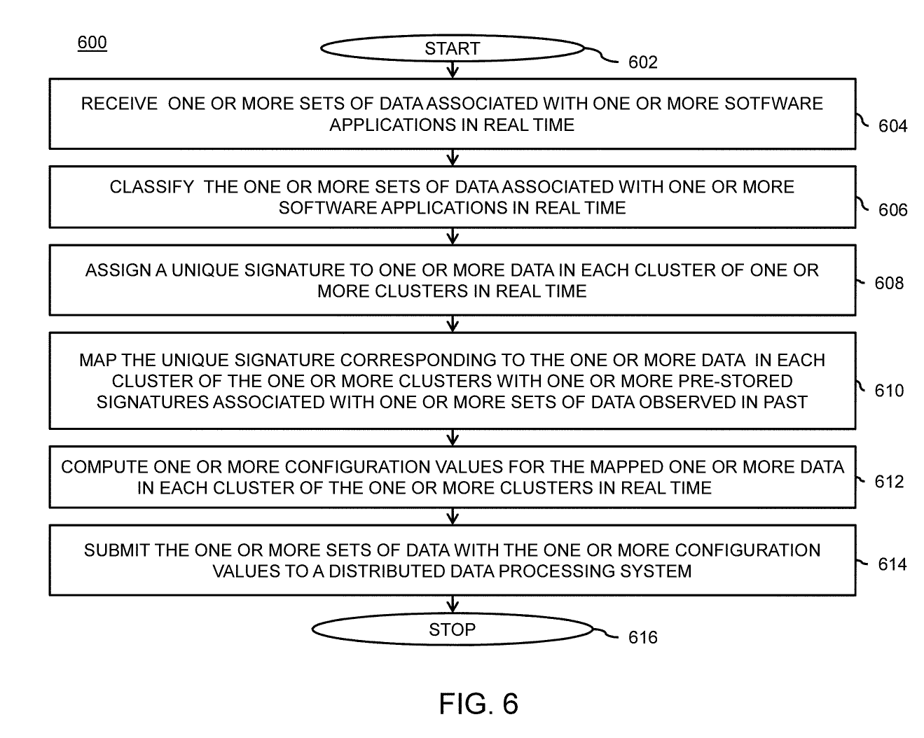

FIG. 6 illustrates a flow chart 600 for monitoring performance of the one or more software applications hosted on the application hosting platform, in accordance with various embodiments of the resent disclosure. It may be noted that to explain the process steps of flowchart 600, references will be made to the system elements of FIG. 1 and FIG. 2. It may be noted that the flowchart 600 may have lesser or more number of steps.

The flowchart 600 initiates at step 602. Following step 602, at step 604, the job submitter 202 receives the one or more sets of data associated with the one or more software applications in real time. At step 606, the job classifier 204 classifies the one or more sets of data associated with the one or more software applications in real time. At step 608, the job classifier 204 assigns the unique signature to the one or more software applications and their data in each cluster of the one or more clusters of applications in a multi-dimensional hyperspace, in real time. At step 610, the learning engine 206 maps the unique signature corresponding to the one or more software applications and their data in each cluster of the one or more clusters with the one or more pre-stored signatures associated with the one or more sets of software applications and data observed in past. At step 612, the learning engine 206 computes one or more configuration values for the one or more software applications and their data in each cluster of the one or more clusters of applications in a multi-dimensional hyperspace, in real time. At step 614, the job submitter 202 submits the one or more software applications and their sets of data with the one or more configuration values to the distributed data processing system 118. The flow chart 600 terminates at step 618.

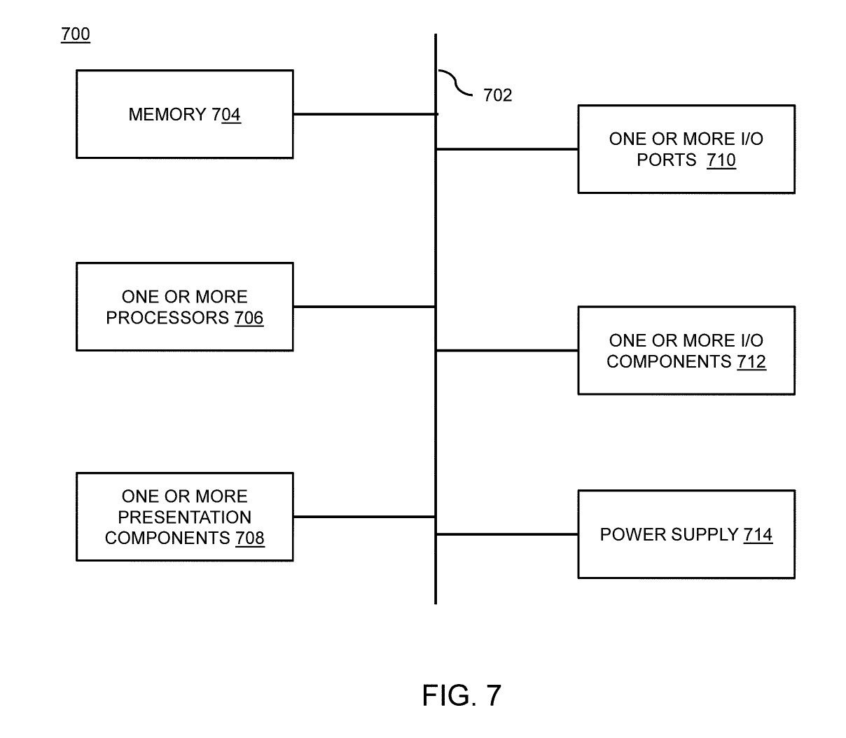

FIG. 7 illustrates a block diagram of a computing device 700, in accordance with various embodiments of the present disclosure. The computing device 700 includes a bus 702 that directly or indirectly couples the following devices: memory 704, one or more processors 706, one or more presentation components 708, one or more input/output (I/O) ports 710, one or more input/output components 712, and an illustrative power supply 714. The bus 702 represents what may be one or more busses (such as an address bus, data bus, or combination thereof). Although the various blocks of FIG. 7 are shown with lines for sake of clarity, in reality, delineating various components is not so clear, and metaphorically, the lines would more accurately be grey and fuzzy. For example, one may consider a presentation component such as a display device to be an I/O component. Also, processors have memory. FIG. 7 is merely illustrative of an exemplary computing device 700 may be used in connection with one or more embodiments of the present disclosure. Distinction is not made between such categories as workstation, server, laptop, hand-held device and the like, as all are contemplated within the scope of FIG. 7 and reference to “the computing device 700.”

The computing device 700 typically includes a computer-readable media. The computer-readable media can be any available media that can be accessed by the computing device 700 and includes both volatile and nonvolatile media, removable and non-removable media. By way of example, and not limitation, the computer-readable media may comprise computer storage media and communication media. The computer storage media includes the volatile and the nonvolatile, the removable and the non-removable media implemented in any method or technology for storage of information such as computer-readable instructions, data structures, program modules or other data. The computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 700. The communication media typically embodies the computer-readable instructions, the data structures, the program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, the communication media includes wired media such as a wired network or direct-wired connection, and wireless media such as acoustic, RF, infrared and other wireless media. Combinations of any of the above should also be included within the scope of the computer readable media.

Memory 704 includes the computer-storage media in the form of volatile and/or nonvolatile memory. The memory 704 may be removable, non-removable, or a combination thereof. Exemplary hardware devices include solid-state memory, hard drives, optical-disc drives and the like. The computing device 700 includes the one or more processors to read data from various entities such as memory 704 or I/O components 712. The one or more presentation components 708 present data indications to a user or other device. Exemplary presentation components include a display device, speaker, printing component, vibrating component and the like. The one or more I/O ports 710 allow the computing device 700 to be logically coupled to other devices including the one or more I/O components 712, some of which may be built in. Illustrative components include a microphone, joystick, game pad, satellite dish, scanner, printer, wireless device and the like.

The foregoing descriptions of specific embodiments of the present technology have been presented for purposes of illustration and description. They are not intended to be exhaustive or to limit present technology to precise forms disclosed, and obviously many modifications and variations are possible in light of above teaching. The embodiments were chosen and described in order to best explain principles of the present technology and its practical application, to thereby enable others skilled in art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from spirit or scope of the claims of the present technology.

While several possible embodiments of the present disclosure have been described above and illustrated in some cases, it should be interpreted and understood as to have been presented only by way of illustration and example, but not by limitation.

Thus, the breadth and scope of a preferred embodiment should not be limited by any of the above-described exemplary embodiments.

What is claimed is:

1. A computer-implemented method for monitoring and controlling performance of one or more software applications hosted on a distributed data processing platform, the computer-implemented method comprising:
receiving, at an application performance control system with a processor, one or more sets of data associated with each of the corresponding one or more software applications in real time;
classifying, at the application performance control system with the processor, the one or more sets of data associated with each of the corresponding one or more software applications in real time, wherein the classifying being done by creating one or more clusters, wherein each of the one or more clusters comprises the one or more software applications and data of the one or more software applications and sets of data which are similar to each other, wherein the one or more software applications and the sets of data is clustered based on determination of whether the received one or more software applications and the one or more sets of data are similar to a pre-stored set of software applications and their data;
assigning, at the application performance control system with the processor, a unique signature to the one or more software applications and the data in each cluster of the one or more clusters of applications in a multi-dimensional hyperspace in real time;
mapping, at the application performance control system with the processor, the unique signature corresponding to the one or more software applications and the data in each cluster of the one or more clusters with one or more pre-stored signatures associated with the one or more software applications and their data observed in past, wherein the mapping being done for determining whether the unique signature corresponding to the one or more software applications and their data in each cluster has been observed in past or not;
computing, at the application performance control system with the processor, one or more configuration values for the mapped one or more software applications and their data in each cluster of the one or more clusters of applications in the multi-dimensional hyperspace in real time, wherein the one or more configuration values being computed for minimizing a cost metric associated with execution of the one or more software applications and their sets of data in real time, wherein the cost metric being minimized for input as an error function for a feedback control matrix, wherein the one or more configuration values being computed based on a pre-determined criterion and wherein the pre-determined criterion being based on a result of the mapping; and
submitting, at the application performance control system with the processor, the one or more software applications and their sets of data with the one or more configuration values to a distributed data processing system.

2. The computer-implemented method as recited in claim 1, further comprising analyzing, at the application performance control system with the processor, the execution of the one or more software applications with their sets of data submitted to the distributed data processing system in real time, wherein the analysis being done for obtaining a completion status, one or more performance metrics and one or more execution logs corresponding to the one or more software applications and their sets of data.

3. The computer-implemented method as recited in claim 2, wherein the completion status and the one or more performance metrics being analyzed for determining one or more issues associated with the performance of the one or more software applications in real time.

4. The computer-implemented method as recited in claim 1, further comprising calculating, at the application performance control system with the processor, the cost metric associated with execution of the one or more sets of data in real time based on one or more performance metrics associated with the one or more sets of data, wherein the calculated cost metric being used as an input for optimization for similar software applications and sets of data in future.

5. The computer-implemented method as recited in claim 1, further comprising storing, at the application performance control system with the processor, completion status, one or more performance metrics, one or more data execution logs corresponding to the one or more sets of data, one or more states of learning, one or more details associated with an infrastructure, one or more details associated with a platform, one or more details associated with the one or more software applications, one or more application signatures, one or more run time metrics and one or more data execution logs.

6. The computer-implemented method as recited in claim 1, wherein the pre-determined criterion comprises assigning one or more specific configuration values to a first set of software applications and data of the one or more software applications and data in each cluster when the unique signature corresponding to the first set of software applications and the data of the one or more software applications and data being observed in past and wherein the one or more specific configuration values being assigned by utilizing a learning engine.

7. The computer-implemented method as recited in claim 1, wherein the pre-determined criterion comprises initializing a new learning object and a learning algorithm for producing a first set of configuration values for the unique signature corresponding to a second set of software applications and data of the one or more software applications and their data being not observed in the past.

8. The computer-implemented method as recited in claim 1, further comprising transmitting, at the application performance control system with the processor, the one or more configurations values to the distributed data processing system in real time when the unique signature has been observed in past and when the unique signature is not observed in past.

9. The computer-implemented method as recited in claim 1, wherein the cost metric being optimized by utilizing one or more optimization algorithms, wherein the one or more optimization algorithms comprises Genetic Algorithm, Artificial Bee Colony, Bayesian Optimization Algorithm, Particle Swarm Optimization Algorithm, Simulated Annealing Algorithm, or their variants, or other similar multi-dimensional optimization algorithms.

10. The computer-implemented method as recited in claim 1, further comprising terminating, at the application performance control system with the processor, execution of one or more processes that are likely to fail, wherein the termination being done to prevent consumption of more than allocated capacity of resources.

11. The computer-implemented method as recited in claim 1, wherein the submitting being done by submitting a first set of information to the application performance control system in real time for optimization of configuration, wherein the first set of information comprises workload information, system information and past set of data, wherein the workload information comprises an execution engine, application code and data to be processed, wherein the system information comprises a number of nodes, resources available, resources in use, and wherein the past set of data comprises values of past inputs, controllable variables and outputs.

12. The computer-implemented method as recited in claim 11, wherein the controllable variables comprises a choice of software stack layers and libraries, configuration parameters for the chosen software stack layers and libraries, number of database connection threads, number of hardware nodes, type of hardware nodes, compiler hints, degree of parallelism of each application, introduction of new domain specific artifacts, efficient ways to read/write files from and to disk, additional caching layers and use of more efficient, alternative implementations of UDFs and operators.

13. A computer system comprising:
one or more processors; and
a memory coupled to the one or more processors, the memory for storing instructions which, when executed by the one or more processors, cause the one or more processors to perform a method for monitoring performance of one or more software applications hosted on an application hosting platform, the computer-implemented method comprising:
receiving, at an application performance control system, one or more sets of data associated with each of the corresponding one or more software applications in real time;
classifying, at the application performance control system, the one or more sets of data associated with each of the corresponding one or more software applications in real time, wherein the classification being done by creating one or more clusters, wherein each of the one or more clusters comprises the one or more software applications with corresponding sets of data of the one or more software applications and their sets of data which are similar to each other, wherein the one or more software applications and their sets of data are clustered based on determination of whether the received one or more software applications and their sets of data are similar to a pre-stored set of software applications and their data;
assigning, at the application performance control system, a unique signature to the one or more software applications and their data in each cluster of the one or more clusters of applications in a multi-dimensional hyperspace in real time;
mapping, at the application performance control system, the unique signature corresponding to the one or more software applications and their data in each cluster of the one or more clusters with one or more pre-stored signatures associated with the one or more software applications and their data observed in past, wherein the mapping being done for determining whether the unique signature corresponding to the one or more software applications and their data in each cluster has been observed in past or not;
computing, at the application performance control system, one or more configuration values for the mapped one or more software applications and their data in each cluster of the one or more clusters of applications in the multi-dimensional hyperspace in real time, wherein the one or more configuration values being computed for minimizing a cost metric associated with execution of the one or more sets of software applications and their data in real time, wherein the cost metric being minimized for input as an error function for a feedback control matrix, wherein the one or more configurations values being computed based on a pre-determined criterion and wherein the pre-determined criterion being based on a result of the mapping; and
submitting, at the application performance control system, the one or more sets of data with the one or more configuration values to a distributed data processing system.

14. The computer system as recited in claim 13, further comprising analyzing, at the application performance control system, the execution of the one or more software applications and corresponding sets of data submitted to the distributed data processing in real time, wherein the analysis being done for obtaining a completion status, one or more performance metrics and one or more execution logs corresponding to the one or more software applications and their sets of data.

15. The computer system as recited in claim 14, wherein the completion status and the one or more performance metrics being analyzed for determining one or more issues associated with associated with the performance of the one or more software applications in real time.

16. The computer system as recited in claim 13, further comprising calculating, at the application performance control system, the cost metric associated with the execution of the one or more software applications and corresponding sets of data in real time based on one or more performance metrics associated with the one or more software applications and their sets of data, wherein the calculated cost metric being used as an input for optimization for similar software applications and sets of data in future.

17. The computer system as recited in claim 13, further comprising storing, at the application performance control system with the processor, completion status, one or more performance metrics, one or more execution logs corresponding to the one or more software applications and their sets of data, one or more states of learning, one or more details associated with an infrastructure, one or more details associated with a platform, one or more details associated with the one or more software applications, one or more application signatures, one or more run time metrics and one or more data execution logs.

18. The computer system as recited in claim 13, further comprising transmitting, at the application performance control system, the one or more configurations values to the distributed data processing system in real time when the unique signature has been observed in past and when the unique signature is not observed in past.

19. The computer system as recited in claim 13, further comprising terminating, at the application performance control system, execution of one or more processes that are likely to fail, wherein the termination being done to prevent consumption of more than allocated capacity of resources.

20. A computer-readable storage medium encoding computer executable instructions that, when executed by at least one processor, performs a method for monitoring performance of one or more software applications hosted on an application hosting platform, the computer-implemented method comprising:
receiving, at a computing device, one or more sets of data associated with each of the corresponding one or more software applications in real time;
classifying, at the computing device, the one or more sets of data associated with each of the corresponding one or more software applications in real time, wherein the classifying being done by creating one or more clusters, wherein each of the one or more clusters comprises the one or more software applications and their corresponding data of the one or more software applications and their sets of data which are similar to each other, wherein the one or more software applications and their sets of data are clustered based on determination of whether the received one or more software applications and their sets of data are similar to a pre-stored set of data;
assigning, at the computing device, a unique signature to the one or more software applications and corresponding data in each cluster of the one or more clusters of applications in a multi-dimensional hyperspace, in real time;
mapping, at the computing device, the unique signature corresponding to the one or more software applications and corresponding data in each cluster of the one or more clusters with one or more pre-stored signatures associated with the one or more software applications and corresponding data observed in past, wherein the mapping being done for determining whether the unique signature corresponding to the one or more software applications and corresponding data in each cluster has been observed in past or not;
computing, at the computing device, one or more configuration values for the mapped one or more software applications and corresponding data in each cluster of the one or more clusters of applications in a multi-dimensional hyperspace, in real time, wherein the one or more configuration values being computed for minimizing a cost metric associated with execution of the one or more sets of software applications and corresponding data in real time, wherein the cost metric being minimized for input as an error function for a feedback control matrix, wherein the one or more configurations values being computed based on a pre-determined criterion and wherein the pre-determined criterion being based on a result of the mapping; and
submitting, at the computing device, the one or more sets of data with the one or more configuration values to a distributed data processing system.
